(19) United States
(12) Patent Application Publication
(10) Pub. No.: US 2010/0149097 A1
(43) Pub. Date: Jun. 17, 2010

(54) APPARATUS AND METHOD FOR PERFORMING CONTINUOUS KEY INPUT USING OPTICAL MOUSE SENSOR IN COMPUTING EQUIPMENT

(75) Inventors: Ra-Mi JUNG, Suwon-si (KR); Chul-Hwan LEE, Seoul (KR)

Correspondence Address: Jefferson IP Law, LLP, 1130 Connecticut Ave., NW, Suite 420, Washington, DC, 20036, US

(73) Assignee: SAMSUNG ELECTRONICS CO. LTD., Suwon-si (KR)

(21) Appl. No.: 12/478,366

(22) Filed: Jun. 4, 2009

(30) Foreign Application Priority Data
Dec. 16, 2008 (KR) 10-2008-0127664

(51) Int. Cl. G06F 3/033

(52) U.S. Cl. 345/166

(57) ABSTRACT

An apparatus and method for processing input of an optical mouse sensor having the optical mouse sensor as an input unit are provided. In the method, a touch movement velocity associated with input of the optical mouse sensor is determined. The movement velocity is compared with a threshold. If the movement velocity is less than the threshold, the input of the optical mouse sensor is processed as continuous key input.

### PRIORITY

This application claims the benefit under 35 U.S.C. § 119(a) of a Korean patent application filed in the Korean Intellectual Property Office on Dec. 16, 2008 and assigned Serial No. 10-2008-0127664, the entire disclosure of which is hereby incorporated by reference.

### BACKGROUND OF THE INVENTION

1. Field of the Invention

The present invention relates to the sensing of input by an optical device. More particularly, the present invention relates to an apparatus and a method for performing continuous input using an optical mouse sensor.

2. Description of the Related Art

An optical mouse is a mouse configured to detect movement using light through an optical sensor, Digital Signal Process (DSP) technology, and optical technology using a lens. When an optical mouse moves, light is emitted from a small Light Emitting Diode (LED), reflected by a surface below the optical mouse, and input to an optical sensor of the optical mouse. Accordingly, when the optical mouse is moved by a user, the optical sensor detects a change in light reflected by the underlying surface, and a DSP chip determines movement distance and direction by analyzing the change in the reflected light.

The above-described operational principle of the optical mouse is being applied to input units of mobile computing equipment such as cellular phones, Personal Digital Assistants (PDAs), lap-top computers, etc. Of course, the optical mouse is applied in a different form due to a limitation in space of the mobile computing equipment. That is, the mobile computing equipment includes an optical sensor fixed to a main body, a user's finger corresponding to the underlying surface of the optical mouse moves on the optical sensor, and so reflected light changes. This type of optical mouse is called a touchpad.

The optical mouse sensor in the mobile computing equipment may operate in a mouse mode or a navigation mode. In the mouse mode, the optical mouse operates like a conventional mouse. That is, the mouse mode is a mode for performing an operation of moving a pointer. The navigation mode is a mode for generating up/down/left/right input depending on a difference value between a start point and an end point of a touch.

Since the optical mouse sensor can be mounted in a narrow space as compared to the space required by navigation keys, the optical mouse sensor is preferred when mobile computing equipment is designed. However, unlike the navigation keys, the optical mouse sensor cannot perform continuous input. In other words, since the optical mouse sensor detects only a difference value between a start point and an end point of a touch, the optical mouse sensor cannot recognize a continuous input, such as the continuously pressed state of a hardware input unit such as the navigation keys. Therefore, when a user intends to make a continuous input in the same direction using computing equipment having only an optical mouse sensor without navigation keys, the user suffers an inconvenience of having to repeatedly manipulate an optical mouse sensor many times in the same direction.

Accordingly, there is a need for an improved apparatus and method for performing a continuous input using an optical device.

### SUMMARY OF THE INVENTION

An aspect of the present invention is to address at least the above-mentioned problems and/or disadvantages and to provide at least the advantages described below. Accordingly, an aspect of the present invention is to provide an apparatus and a method for resolving an inconvenience of having to repeatedly manipulate an optical mouse sensor many times when making continuous input.

Another aspect of the present invention is to provide an apparatus and a method for realizing continuous key input through an optical mouse sensor in a navigation mode.

Still another aspect of the present invention is to provide an apparatus and a method for determining whether continuous key input is made using a movement velocity of input of an optical mouse sensor.

According to an aspect of the present invention, a method for processing optical mouse sensor input is provided. The method includes determining a touch movement velocity associated with input of the optical mouse sensor, comparing the movement velocity with a first threshold and, when the movement velocity is less than the first threshold, processing the input of the optical mouse sensor as continuous key input.

According to another aspect of the present invention, an apparatus having an optical mouse sensor as an input unit is provided. The apparatus includes a determination unit for determining a touch movement velocity associated with input of the optical mouse sensor and for comparing the movement velocity with a first threshold and a controller for, when the movement velocity is less than the first threshold, processing the input of the optical mouse sensor as continuous key input.

Other aspects, advantages and salient features of the invention will become apparent to those skilled in the art from the following detailed description, which, taken in conjunction with the annexed drawings, discloses exemplary embodiments of the invention

### BRIEF DESCRIPTION OF THE DRAWINGS

The above and aspects objects, features and advantages of certain exemplary embodiments of the present invention will be more apparent from the following description taken in conjunction with the accompanying drawings in which:

FIG. 1 is a block diagram illustrating an apparatus according to an exemplary embodiment of the present invention; and

FIG. 2 is a flowchart illustrating a procedure for processing optical mouse sensor input according to an exemplary embodiment of the present invention.

Throughout the drawings, like reference numerals will be understood to refer to like parts, components and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to skill in the art, may occur in amounts that do not preclude the effect the characteristic was intended to provide.

Exemplary embodiments of the present invention provide technology for realizing continuous key input through an optical mouse sensor in a navigation mode. In the following description, an apparatus in which the optical mouse sensor is deployed may include a cellular phone, a Personal Communication System (PCS), a Personal Digital Assistant (PDA), an International Mobile Telecommunication-2000 (IMT2000) terminal, a lap-top computer, a desk-top computer and the like.

Input information that may be recognized through the optical mouse sensor includes recognition of a touch start point, recognition of a touch end point, and duration of a touch. Therefore, the apparatus according to an exemplary embodiment of the present invention identifies continuous input using a movement velocity of the touch. In other words, the apparatus determines whether user manipulation is a single key input or continuous key input depending on a distance between the start point and the end point, and a duration during which the touch moves. More specifically, when the movement velocity of a touch is more than a threshold, the apparatus interprets and processes the manipulation as a single input, for example an input of a single key stroke. Alternatively, when the movement velocity of a touch is less than the threshold, the apparatus interprets and processes the manipulation as a continuous input. The processing as continuous key input may include one of paging up/down, inputting of a key a set number of times, and inputting of a key a number of times inversely proportional to a movement velocity.

In an exemplary implementation, the performance of continuous input is determined depending on the character of a screen currently displayed. That is, the apparatus does not always perform the continuous input but instead performs the continuous input only in the case where the continuous input is applicable. For example, when a scroll bar is displayed on a screen, or the number of items displayed on the screen exceeds a threshold, the apparatus may determine that the continuous input can be performed. Here, a situation where the continuous input is required can change depending on the intent and purpose of an operator. For convenience of description, a state of determining whether a continuous input is made through an optical mouse sensor in a navigation mode is referred as a ‘continuous key recognition mode’ in the present invention.

Hereinafter, an exemplary construction and operating procedure of an apparatus for determining continuous input will be described in more detail with reference to the accompanying drawings.

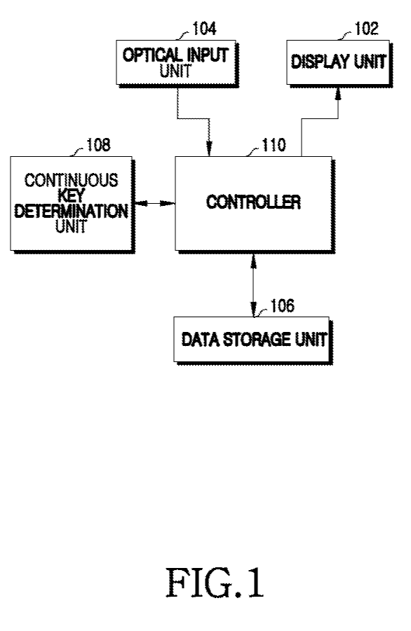

FIG. 1 is a block diagram illustrating an apparatus according to an exemplary embodiment of the present invention.

As illustrated in FIG. 1, the apparatus includes a display unit 102, an optical input unit 104, a data storage unit 106, a continuous key determination unit 108, and a controller 110.

The display unit 102 displays visual information. That is, the display unit 102 displays the state of a mobile terminal, numbers, letters, images and the like in a visual form which can be seen by a user under control of the controller 110. For example, the display unit 102 can be one of a Cathode Ray Tube (CRT), a Liquid Crystal Display (LCD), an Organic Light-Emitting Diode (OLED) and the like.

The optical input unit 104 includes an optical sensor and processes touch information generated by coupling between the optical sensor and an external object. That is, when optical coupling between the optical sensor and the external object is sensed, the optical input unit 104 recognizes a touch start point, a touch end point, touch duration, and a touch movement direction. Also, the optical input unit 104 converts the touch start point, the touch end point, the touch duration, and the touch movement direction into data, and then provides the data to the controller 110. Of course, as used herein, the term “touch” denotes a physical touch or contact by a user on the optical input unit 104 as well as an optical coupling without a physical contact between the user and the optical input unit 104.

The data storage unit 106 may store an operating system required for operating the apparatus, an application program for providing service, data generated during an operation, and user contents. Also, the data storage unit 106 may provide a program code in response to a request of the controller 110, and store data provided by the controller 110. That is, the data storage unit 106 may provide the program code for performing an operation corresponding to key input determined by the controller 110.

The continuous key determination unit 108 determines whether a continuous input is made when key input, made by a user, is detected and recognized by the optical input unit 104. In an exemplary implementation, the continuous key determination unit 108 determines whether a continuous input is made only in the case where the optical mouse sensor operation mode is a navigation mode. That is, when the optical mouse sensor operation mode is the navigation mode and input through the optical input unit 104 occurs, the continuous key determination unit 108 determines whether continuous input is made by evaluating a movement velocity of the input. In more detail, the continuous key determination unit 108 determines the movement velocity of the input. In other words, the continuous key determination unit 108 determines a movement distance of the touch using a start point of the touch and an end point of the touch, and determines the movement velocity by dividing the movement distance by the duration of the touch. At this point, when the movement velocity is less than a threshold, the continuous key determination unit 108 determines that the input is continuous. The continuous key determination unit 108 also informs the controller 110 that the input is continuous.

The controller 110 controls the function of the apparatus. For example, the controller 110 provides image data to the display unit 102, and performs a process corresponding to a program code provided from the data storage unit 106. Particularly, during a continuous key recognition mode, the controller 110 processes signals corresponding to input received through the optical input unit 104 according to the determination of the continuous key determination unit 108. In an exemplary implementation, when a scroll bar is displayed on a screen or the number of items exceeds a threshold, the controller determines it is in the continuous key recognition mode. Accordingly, when input information is received from the optical input unit 104, the controller 110 provides parameters required for determining whether the input is continuous to the continuous key determination unit 108. Also, when it is informed by the continuous key determination unit 108 that the input is continuous, the controller 110 processes the input as continuous input. For example, the controller 110 may move a page in a direction corresponding to a touch movement direction of the input, or process the input as a plurality of inputs of a navigation key corresponding to the touch movement direction.

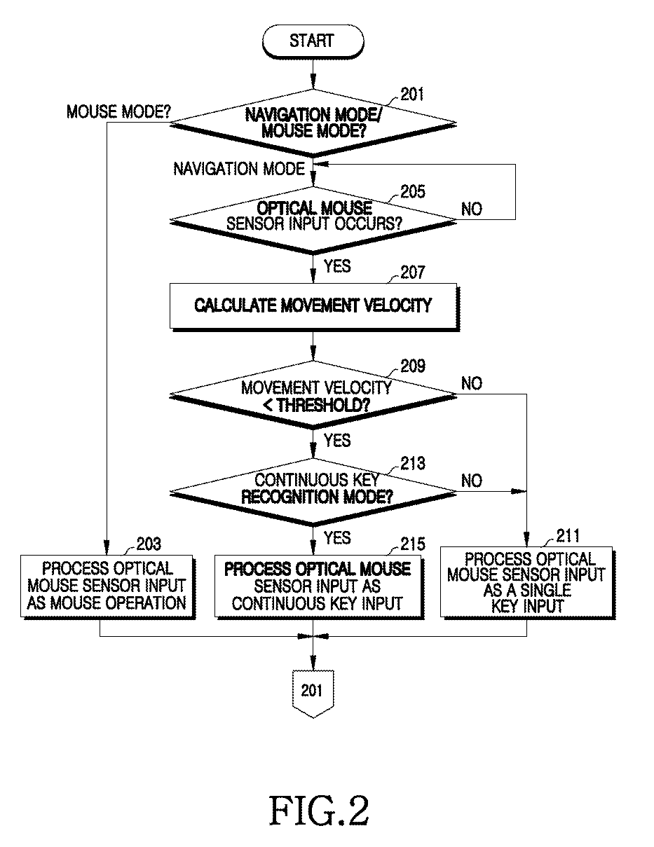

FIG. 2 is a flowchart illustrating a procedure for processing optical mouse sensor input according to an exemplary embodiment of the present invention.

As illustrated in FIG. 2, in step 201, the apparatus determines whether the operation mode of the optical mouse sensor is a navigation mode or a mouse mode. That is, the apparatus determines whether to process input of the optical mouse sensor as mouse input or navigation key input.

If it is determined that the operation mode of the optical mouse sensor is the mouse mode, the apparatus processes the input of the optical mouse sensor as a mouse operation in step 203. In other words, when the movement of a touch is recognized through the optical mouse sensor, the apparatus moves a cursor in a direction corresponding to the movement direction of the touch.

On the other hand, if it is determined in step 201 that the operation mode of the optical mouse sensor is the navigation mode, the apparatus determines whether input of the optical mouse sensor is generated in step 205. Here, the input of the optical mouse sensor includes a start point of a touch, an end point of the touch, duration of the touch, and a movement direction of the touch.

When the input of the optical mouse sensor occurs, the apparatus determines a movement velocity of the input in step 207. In other words, the apparatus determines the movement distance using the start point of the touch and the end point of the touch, and determines the movement velocity by dividing the movement distance by the duration of the touch. Using the determined velocity and an index, the apparatus determines whether an input is continuous.

More specifically, after determining the movement velocity, the apparatus determines whether the movement velocity is less than an index or threshold in step 209. In other words, the apparatus determines whether the input meets a condition that indicates the input is continuous.

When the movement velocity is greater than the threshold, the apparatus processes the input of the optical mouse sensor received in step 205 as a single key input in step 211. That is, the apparatus determines a navigation key corresponding to the touch movement direction and forming the input of the optical mouse sensor that has been input one time.

On the other hand, when the movement velocity is less than the threshold, the apparatus determines whether the continuous key recognition mode is currently performed in step 213. In other words, the apparatus determines whether it is currently in a situation in which the continuous key input is applicable. For example, the apparatus determines whether a scroll bar is displayed on a screen or the number of items displayed on the screen exceeds a threshold. When the continuous key recognition mode is not currently performed, the apparatus performs step 211.

On the other hand, when the continuous key recognition mode is currently performed, the apparatus processes the input of the optical mouse sensor received in step 205 as continuous input in step 215. For example, the apparatus moves a page in a direction corresponding to the touch input of the optical mouse sensor, or processes the input as a plurality of inputs of a navigation key corresponding to the touch movement direction.

As described above, the apparatus having the optical mouse sensor as an input unit recognizes continuous key input through the optical mouse sensor, so that user's inconvenience of having to repeatedly manipulate the optical mouse sensor when a continuous key is input is addressed.

Although the invention has been shown and described with reference to certain exemplary embodiments thereof, it will be understood by those skilled in the art that various changes in form and details may be made therein without departing from the spirit and scope of the invention as defined by the appended claims. Therefore, the scope of the present invention should not be limited to the above-described embodiments but should be determined by not only the appended claims but also the equivalents thereof.

What is claimed is:

1. A method for processing optical mouse sensor input of an apparatus having an optical mouse sensor as an input unit, the method comprising:
determining a touch movement velocity associated with input of the optical mouse sensor;
comparing the movement velocity with a first threshold; and
processing the input of the optical mouse sensor as continuous key input when the movement velocity is less than the first threshold.

2. The method of claim 1, wherein the processing of the input of the optical mouse sensor as the continuous key input comprises moving a page in a direction corresponding to the touch movement.

3. The method of claim 1, wherein the processing of the input of the optical mouse sensor as the continuous key input comprises processing the input as an input of a navigation key, corresponding to a direction of the touch movement, a set number of times.

4. The method of claim 1, wherein the processing of the input of the optical mouse sensor as the continuous key input comprises processing the input as an input of a navigation key corresponding to a direction of the touch movement a number of times inversely proportional to the movement velocity.

5. The method of claim 1, wherein the determining of the touch movement velocity comprises:
determining an operation mode of the optical mouse sensor; and
determining the touch movement velocity if the operation mode comprises a navigation mode.

6. The method of claim 1, further comprising determining if an operation mode of the optical mouse sensor is a continuous key recognition mode, wherein the processing of the input of the optical mouse sensor as the continuous key input is performed during the continuous key recognition mode.

7. The method of claim 6, further comprising, when at least one of the movement velocity is more than the first threshold and the apparatus is not in the continuous key recognition mode, processing the input of the optical mouse sensor as a single input of a navigation key corresponding to a touch movement direction.

8. The method of claim 6, wherein the determining if the operation mode of the optical mouse sensor is a continuous key registration mode comprises determining if at least one of a scroll bar is displayed on a screen and a number of items displayed on the screen exceeds a second threshold.

9. The method of claim 1, further comprising determining if the optical mouse sensor is in a navigation mode prior to the determining of the touch movement velocity.

10. An apparatus having an optical mouse sensor as an input unit, the apparatus comprising:
a determination unit for determining a touch movement velocity associated with input of the optical mouse sensor and for comparing the movement velocity with a first threshold; and
a controller for processing the input of the optical mouse sensor as continuous key input when the movement velocity is less than the first threshold.

11. The apparatus of claim 10, wherein when the movement velocity is less than the first threshold, the controller processes the input of the optical mouse sensor as a page movement in a direction corresponding to the touch movement.

12. The apparatus of claim 10, wherein when the movement velocity is less than the threshold, the controller processes the input of the optical mouse sensor as inputs of a navigation key corresponding to a direction of the touch movement by a set number of times.

13. The apparatus of claim 10, wherein when the movement velocity is less than the first threshold, the controller processes the input of the optical mouse sensor as an input of a navigation key, corresponding to a direction of the touch movement, the number of times inversely proportional to the movement velocity.

14. The apparatus of claim 10, wherein when an operation mode of the optical mouse sensor is a navigation mode, the determination unit determines the movement velocity.

15. The apparatus of claim 10, wherein the controller processes the input of the optical mouse sensor as continuous key input during a continuous key recognition mode.

16. The apparatus of claim 15, wherein, when at least one of the movement velocity is more than the first threshold and the apparatus is not in the continuous key recognition mode, the controller processes the input of the optical mouse sensor as a single input of a navigation key corresponding to a touch movement direction.

17. The apparatus of claim 15, wherein the controller determines the continuous key recognition mode by determining if at least one of a scroll bar is displayed on a screen and a number of items displayed on the screen exceeds a second threshold.

18. The apparatus of claim 10, wherein the controller determines if the optical mouse sensor is in a navigation mode prior to the determining of the touch movement velocity.
